(19) United States
(12) Patent Application Publication
(10) Pub. No.: US 2010/0045566 A1
(43) Pub. Date: Feb. 25, 2010

(54) SATELLITE BROADCAST RECEIVING CONVERTER

(75) Inventors: Takehito Kuno, Nisshin-shi (JP); Koji Yokoi, Nisshin-shi (JP); Kenzi Suzuki, Nisshin-shi (JP)

Correspondence Address: GROSSMAN, TUCKER, PERREAULT & PFLEGER, PLLC, 55 SOUTH COMMERICAL STREET, MANCHESTER, NH, 03101, US

(73) Assignee: MASPRODENKOH KABUSHIKIKAISHA, Nisshin-shi (JP)

(21) Appl. No.: 12/593,796

(22) PCT Filed: Mar. 18, 2008
(86) PCT No.: PCT/JP2008/054985

§ 371 Date: Sep. 29, 2009

(30) Foreign Application Priority Data
Mar. 30, 2007 (JP) 2007-092554

(51) Int. Cl. H01Q 1/00; H01Q 13/02

(52) U.S. Cl. 343/908

(57) ABSTRACT

A satellite broadcast receiving converter includes a feedhorn to which a satellite broadcast radio wave is input, a circuit board on which a converting element for receiving and converting the satellite broadcast radio wave to an electric signal is mounted, and a support case which is provided on the periphery on the back end side of the feedhorn, and which supports and positions the circuit board at a position at which the satellite broadcast radio wave can be received. The feedhorn and the support case are made of synthetic resin formed by plating a surface of the synthetic resin with metal. At least the opening surface side surface and the inner side surface which serves as a waveguide path of the feedhorn are plated with metal. At least the inner side surface of the support case positioned between the inner wall of the feedhorn and a ground pattern of the circuit board is plated with metal. Further, the cross-sectional surface of a corner section surrounded by two or more wall surfaces of the metal-plated sections of the feedhorn and the support case is formed into an arc shape so as not to allow an air space to be formed at the time of plating.

### TECHNICAL FIELD

The present invention relates to a satellite broadcast receiving converter including a feedhorn and a case formed of synthetic resin.

### BACKGROUND ART

A satellite broadcast receiving converter disposed at a focal position of a parabolic reflector receives a satellite broadcast radio wave and converts the received radio wave to an intermediate frequency signal having a predetermined frequency band to be output. In such satellite broadcast receiving converter, it is conventionally proposed to form a feedhorn and a case, for receiving the satellite broadcast radio wave, made of synthetic resin formed by plating the surface of the synthetic resin with metal (see, for example, Patent Documents 1, 2, and so on).
Patent Document 1: Unexamined Japanese Patent Publication No. 2001-119202
Patent Document 2: Unexamined Japanese Patent Publication No. 2004-7043

### DISCLOSURE OF THE INVENTION

### Problems To Be Solved By the Invention

In the case of forming the feedhorn and the case made of synthetic resin as above, however, the surface of the resin is sometimes unable to be uniformly plated with metal, depending on the shape of the feedhorn and the case. The receiving characteristic of the satellite receiving converter is thus deteriorated.

Specifically, when forming a conductive layer by plating the surface of the synthetic resin with metal, firstly a layer of copper is formed on the resin surface by nonelectrolytic plating with copper, in general. Thereafter, electrolytic plating is performed in which electricity flows on the resin surface by making use of the formed layer of copper, to form a layer of nickel or chromium thereon.

In nonelectrolytic plating, however, if there is a corner surrounded by two or more of wall surfaces, an air space is generated at the corner. As a result, the corner is unable to be plated. Also, in electrolytic plating, if such corner exists in synthetic resin, an area where electricity (electric field) is concentrated and an area where electricity is dispersed are produced on the resin surface. As a result, the produced conductive layer may become uneven.

When there is an area without a conductive layer on the surface of the synthetic resin constituting the feedhorn or the case, or when a conductive layer is uneven, a radio wave leaks and a desired receiving characteristic is unable to be obtained.

The present invention is made so as to solve the above-described problems. One object of the invention is to keep the receiving characteristic of a satellite broadcast receiving converter, including a feedhorn and a case formed of synthetic resin, from being deteriorated due to defective plating by forming these components into shapes easy to be plated with metal.

### Means For Solving the Problem

A first aspect of the invention, which was made to solve the above-described problems, provides a satellite broadcast receiving converter including a feedhorn, a circuit board, and a support case. A satellite broadcast radio wave is input to the feedhorn. A converting element for receiving and converting the satellite broadcast radio wave to an electric signal is mounted on the circuit board. The support case is provided on a periphery on a back end side of the feedhorn, and supports and positions the circuit board at a position at which the satellite broadcast radio wave can be received. The feedhorn and the support case are made of synthetic resin formed by plating a surface of the synthetic resin with metal. At least an opening surface side surface and an inner side surface which serves as a waveguide path of the feedhorn are plated with metal. At least an inner side surface of the support case positioned between an inner wall of the feedhorn and a ground pattern of the circuit board is plated with metal. A cross-sectional surface of a corner section surrounded by two or more wall surfaces of metal-plated sections of the feedhorn and the support case is formed into an arc shape so as not to allow an air space to be formed at a time of plating.

A second aspect of the invention provides the satellite broadcast receiving converter according to the first aspect, wherein the feedhorn and the support case are integrally formed of synthetic resin.

A third aspect of the invention provides the satellite broadcast receiving converter according to the first or the second aspect, wherein a corrugated portion that includes a groove section and a wall section disposed to interpose the groove section is formed on a periphery of an opening end of the feedhorn, and the wall section is partly notched to a bottom surface of the groove section.

A fourth aspect of the invention provides the satellite broadcast receiving converter according to one of the first to the third aspects, wherein a corrugated portion that includes a groove section and a wall section disposed to interpose the groove section is formed on a periphery of an opening end of the feedhorn, and a hole that penetrates to a back end surface of the groove section is provided in a bottom surface of the groove section.

A fifth aspect of the invention provides the satellite broadcast receiving converter according to the third or the fourth aspect, wherein a cross-sectional surface of the groove section is formed into a U-shape.

A sixth aspect of the invention provides the satellite broadcast receiving converter according to the first or the second aspect, wherein a corrugated portion is formed on a periphery of an opening end of the feedhorn by fitting a metal-plated annular synthetic resin thereon.

The seventh aspect of the invention provides the satellite broadcast receiving converter according to one of the first to the sixth aspects, wherein an arm fixture for fixing the satellite broadcast receiving converter to a front end of an arm drawn from a parabolic reflector to its focal position protrudes from the support case, and the arm fixture is not plated with metal so that the synthetic resin remains exposed.

### Effect of the Invention

In the satellite broadcast receiving converter according to the first aspect of the invention, the feedhorn and the support case which positions the circuit board at the back end side of the feedhorn is formed of synthetic resin. At least the opening surface side surface and the inner side surface which serves as a waveguide path of the feedhorn are plated with metal. At least the inner side surface of the support case positioned between the inner wall of the feedhorn and the ground pattern of the circuit board is plated with metal. The cross-sectional surface of the corner section surrounded by two or more wall surfaces of metal-plated sections of the feedhorn and the support case is formed into an arc shape so as not to allow an air space to be formed at a time of plating.

According to the present invention, it is possible to inhibit defective plating due to formation of an air space at nonelectrolytic plating of the feedhorn and the support case. It is also possible, in later electrolytic plating, to keep the plating around the corner section from being uneven due to formation of an area where electricity is concentrated and an area where electricity is dispersed. The satellite broadcast radio wave received via the feedhorn can be efficiently converted to an electric signal by a conversion element implemented on the circuit board.

The cross sectional shape of the corner section suitable to be plated is an arc shape. It is preferable that the radius of the arc is 1-1.5 mm or above. Specifically, the smallest diameter of a hole capable of being plated is different depending on viscosity of a plating liquid. However, as noted above, if a copper layer is formed by nonelectrolytic plating and then forming a nickel layer or a chromium layer on the copper layer, the smallest diameter of a hole capable of being plated becomes 2-3 mm. Accordingly, in case that the cross-sectional surface of the corner section is formed into an arc shape, it is preferable that the radius of the arc is at least 1-1.5 mm in accordance with the smallest diameter of a hole capable of being plated.

The larger the radius of the arc is, the more possible it is to inhibit defective plating. However, if the radius of the arc is increased, the amount of synthetic resin forming the feedhorn and the support case is increased, which becomes a hindrance to weight reduction. Therefore, it is preferable that the radius of the arc is reduced to an extent that the plating is not obstructed, and is equal to or under 2.5 mm at a maximum.

Now, in the satellite broadcast receiving converter according to the second aspect of the invention, the feedhorn and the support case are integrally formed of synthetic resin. Accordingly, it becomes unnecessary to form the feedhorn of synthetic resin, form a case of the circuit board from a metal plate, and then bring the feedhorn and the case together, as in the conventional satellite broadcast receiving converter. A satellite broadcast receiving converter can be produced at low cost.

In the satellite broadcast receiving converter according to the third aspect of the invention, a corrugated portion that includes a groove section and a wall section disposed to interpose the groove section is formed on a periphery of an opening end of the feedhorn. The wall section is partly notched to a bottom surface of the groove section.

Accordingly, at the time of plating the feedhorn, the plating liquid enters into the groove section through the notches of the wall section. Defective plating can be avoided between the feedhorn and the corrugated portion due to generation of an air space in the groove section.

According to the satellite broadcast receiving converter of the present invention, even if the corrugated portion is formed of synthetic resin on a periphery of the feedhorn, electric connection between the corrugated portion and the feedhorn can be secured. The receiving characteristic (directional characteristic) can be improved by the corrugated portion.

The larger the width of the notches formed on the wall section is, the easier it becomes for the plating liquid to pass through the notches. However, if the width becomes too large, the receiving characteristic is deteriorated.

According to the experiments by the inventors of the present application, if the satellite broadcast receiving converter receives a satellite broadcast radio wave (a radio wave in ten and several GHz band) from a satellite broadcast (or a communication satellite), the notches of about 5 mm wide formed on the wall section did not change the receiving characteristic of the satellite broadcast receiving converter.

Accordingly, if the notches through which the plating liquid passes are formed on the wall section of the corrugated portion disposed on the periphery of the feedhorn, as in the third aspect, the notches can be about 5 mm wide.

In the satellite broadcast receiving converter according to the fourth aspect of the invention, a corrugated portion that includes a groove section and a wall section disposed to interpose the groove section is formed on a periphery of an opening end of the feedhorn, and a hole that penetrates to a back end surface of the groove section is provided in a bottom surface of the groove section.

Accordingly, at the time of plating the feedhorn, the plating liquid enters into the groove section through the hole of the wall section. Defective plating can be avoided between the feedhorn and the corrugated portion due to generation of an air space in the groove section.

According to the satellite broadcast receiving converter of the present invention, even if the corrugated portion is formed of synthetic resin on the periphery of the feedhorn, electric connection between the corrugated portion and the feedhorn can be secured, as in the satellite broadcast receiving converter according to the third aspect. The receiving characteristic (directional characteristic) can be improved by the corrugated portion.

In case that the hole through which the plating liquid passes is bored in the bottom surface of the groove section, the diameter of the hole may be consistent with the width of the groove section since the larger the diameter is, the better. The width of the groove section is necessary to be set to 2-3 mm or above in accordance with the smallest diameter of the hole capable of being plated. Therefore, the diameter of the hole bored in the bottom of the groove section may be set as well in accordance with the smallest diameter of the hole capable of being plated.

In the satellite broadcast receiving converter according to the fifth aspect of the invention, a cross-sectional surface of the groove section is formed into a U-shape. Accordingly, as compared to the case in which a plane surface is formed on the bottom of the groove section, the interior of the groove section can be plated with metal in a more favorable manner. The receiving characteristic (directional characteristic) of the satellite broadcast receiving converter can be improved.

In the satellite broadcast receiving converter according to the sixth aspect of the invention, a corrugated portion is formed on a periphery of an opening end of the feedhorn by fitting a metal-plated annular synthetic resin thereon.

According to the satellite broadcast receiving converter of the present invention, the periphery of the opening end of the feedhorn and the synthetic resin forming the corrugated portion can be separately plated with metal. No defective plating results in the groove section of the corrugated portion disposed on the periphery of the feedhorn.

Accordingly, in the satellite broadcast receiving converter according to the sixth aspect as well, it is possible to make the corrugated portion normally function and improve the receiving characteristic (directional characteristic) of the satellite broadcast receiving converter, as in the satellite broadcast receiving converters according to the third to the fifth aspects.

In the satellite broadcast receiving converter according to the seventh aspect of the invention, an arm fixture for fixing the satellite broadcast receiving converter to a front end of an arm drawn from a parabolic reflector to its focal position protrudes from the support case, and the arm fixture is not plated with metal so that the synthetic resin remains exposed.

Accordingly, the satellite broadcast receiving converter of the present invention can be easily attached to the front end of the arm drawn from the parabolic reflector via the arm fixture provided on the support case in a protruding manner. Moreover, the attachment section is formed of insulating synthetic resin without being plated with metal. Thus, the satellite broadcast receiving converter is insulated from the parabolic reflector. It is possible to inhibit the satellite broadcast receiving converter from being grounded.

### BRIEF DESCRIPTION OF THE DRAWINGS

FIG. 1 is a perspective view showing a constitution of a receiving antenna according to an embodiment;

FIGS. 2A-2C are explanatory views showing an appearance of a converter according to the embodiment;

FIGS. 3A-3B are explanatory views showing an internal constitution of the converter illustrated in FIGS. 2A-2C;

FIG. 4 is a block diagram showing a constitution of an electric circuit formed on a circuit board; and

FIGS. 5A-5E are explanatory views showing variations of the converter.

### EXPLANATION OF REFERENTIAL NUMERALS

2 . . . receiving antenna, 4 . . . parabolic reflector, 6 . . . arm, 8 . . . converter, 10 . . . feedhorn, 12 . . . support case, 14 . . . back cover, 16 . . . end terminal fixture, 18 . . . arm fixture, 20 . . . wall section, 21 . . . corrugated portion, 22 . . . groove section, 24 . . . notch, 26 . . . concave section, 28 . . . annular member, 29 . . . hole, 30 . . . circuit board, 32 . . . end terminal, 40 . . . shield case, 50 . . . signal converter

### DETAILED DESCRIPTION OF PREFERRED EMBODIMENTS OF THE INVENTION

Hereinafter, an embodiment of the present invention will be described by way of drawings.

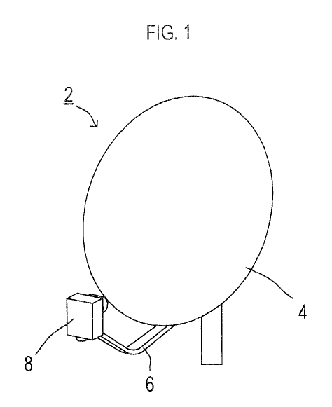

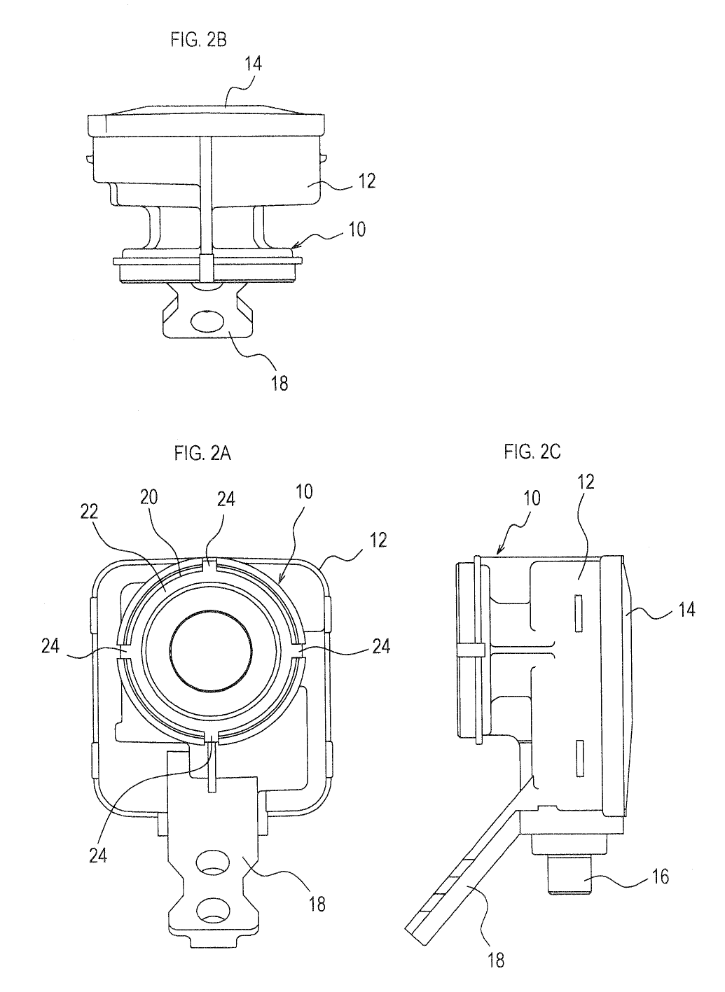

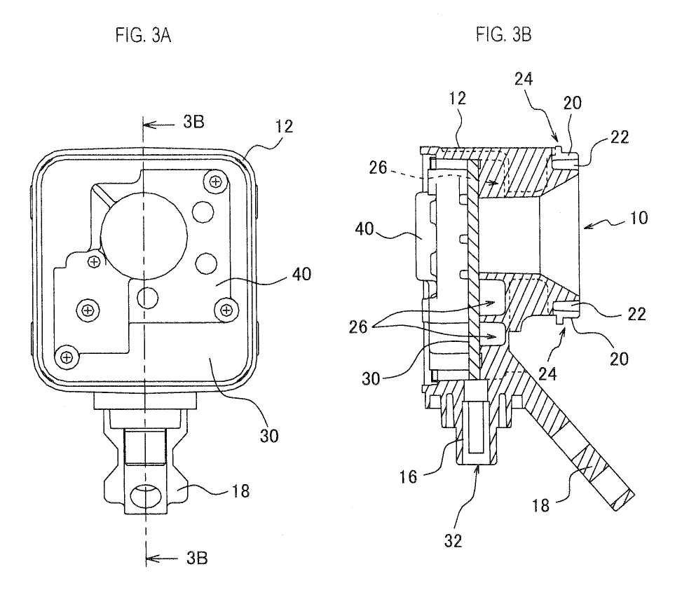

In the following description, FIG. 1 is a perspective view showing a constitution of a receiving antenna according to an embodiment of the present invention. FIGS. 2A-2C are explanatory views showing an appearance of a satellite broadcast receiving converter (hereinafter, simply referred to as a converter) provided in the receiving antenna. FIGS. 3A and 3B are explanatory views showing the converter without a back cover.

FIG. 2A is a front view of the converter taken from an opening end side of a horn. FIG. 2B is a plane view of the converter of FIG. 2A taken from the above. FIG. 2C is a side view of the converter of FIG. 2A taken from the right side.

FIG. 3A is a back view of the converter taken from a side opposite to the opening end of the horn. FIG. 3B is a cross sectional view of the converter taken by a line 3B-3B of FIG. 3A.

The receiving antenna 2 of the present embodiment is used for receiving a radio wave in ten and several GHz band transmitted from a broadcast satellite (BS) or a communication satellite (CS). As shown in FIG. 1, the receiving antenna 2 is constituted from a parabolic reflector 4 and the converter 8 disposed at a focal position of the parabolic reflector 4 via an arm 6.

The converter 8 receives a radio wave collected by the parabolic reflector 4, then converts the received signal to an intermediate frequency signal of one to several GHz band, and outputs the converted signal. As shown in FIGS. 2A-2C, the converter 8 includes a feedhorn 10 and a support case 12. The feedhorn 10 receives a radio wave reflected and converged by the parabolic reflector 4. The support case 12 is integrally formed at a back end of the feedhorn 10 to support and position a receiving circuit board 30 (see FIG. 2B) at the back end of the feedhorn 10.

A corrugated portion 21 is provided on a periphery of the opening end of the feedhorn 10. The corrugated portion 21 includes a groove section 22 and a wall section 20 that is disposed to interpose the groove section 22. The side opposite to the feedhorn 10 of the support case 12 is formed into a box-like shape capable of housing the circuit board 30 therein. The side opposite to the feedhorn 10 of the support case 12 is open so as to be able to accommodate the circuit board 30 therein. The opening of the support case 12 is sealed with the back cover 14.

The feedhorn 10, the support case 12, and the corrugated portion 21 are integrally formed of synthetic resin. The back cover 14, made of synthetic resin, is formed capable of being fitted to the opening on the side opposite to the feedhorn 10 of the support case 12.

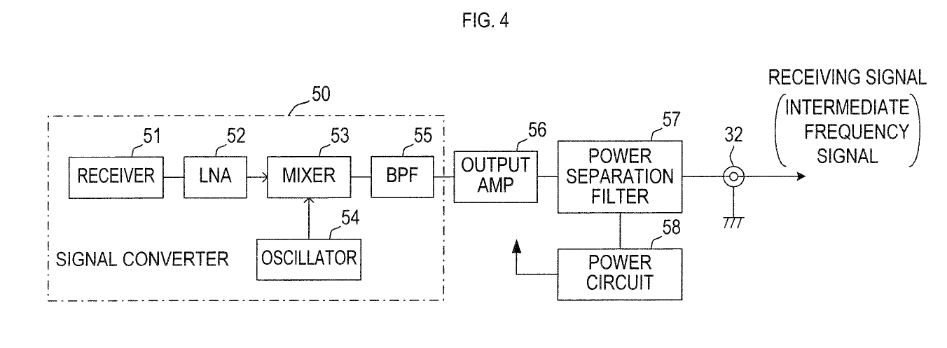

Metal plating is applied to the surface on the opening end side of the feedhorn 10 which includes the corrugated portion 21 provided with the wall section 20 and the groove section 22, the inner side surface of the feedhorn 10 which serves as a waveguide path, and the inner side surface of the support case 12 from the inner side surface of the feedhorn 10 till an abutting section which abuts on the circuit board 30. A metallic shield case 40 that covers a signal converter 50 (see FIG. 4) which receives and converts a radio wave into an intermediate frequency signal is provided on the board surface on the side opposite to the feedhorn 10 of the circuit board 30.

The shield case 40 is screwed to the support case 12 in a state that the circuit board 30 is interposed between the shield case 40 and the support case 12. On the board surface of the circuit board 30, a ground pattern is formed to surround the signal converter 50 in a section which abuts on the support case 12 and in a section which abuts on the opening end of the shield case 40.

Accordingly, the signal converter 50 of the circuit board 30 is shielded by a conductive layer formed by plating the inner side surface of the support case 12 with metal, and the shield case 40, except for an inner section which abuts on a back end surface of the feedhorn 10.

An end terminal fixture 16 for securing an end terminal 32 that takes out a receiving signal (intermediate frequency signal) from the circuit board 30 is formed on a side wall of the support case 12 (a lower side wall in FIGS. 2A-2C, 3A and 3B). The circuit board 30 is connected to the end terminal 32 secured to the end terminal fixture 16.

Specifically, as shown in FIG. 4, the circuit board 30 includes an output amplifying circuit (output AMP) 56, a power separation filter 57, and a power circuit 58, in addition to the signal converter 50 that converts a satellite broadcast radio wave received via the feedhorn 10 to an electric signal and further converts the received signal to an intermediate frequency signal. The output amplifying circuit 56 amplifies the intermediate frequency signal after frequency conversion and outputs the amplified signal from the end terminal 32 to a receiving terminal side. The power separation filter 57 separates a direct current voltage input to the end terminal 32 from the receiving terminal side. The power circuit 58 generates a power voltage, which activates the output AMP 56 and the signal converter 50, from the direct current voltage separated in the power separation filter 57. The output AMP 56 is connected to the end terminal 32 via the power separation filter 57.

In the circuit board 30, the signal converter 50 shielded by the shield case 40 and others includes a receiver 51, an amplifying circuit (a low noise amplifier; LNA) 52, an oscillator 54, a mixer 53, and a band pass filter (BPF) 55. The receiver 51 includes a probe or the like which is a conversion element for converting a satellite broadcast radio wave to an electric signal. The amplifying circuit 52 amplifies the receiving signal from the receiver 51. The oscillator 54 generates a high-frequency signal (frequency: ten and several MHz) for frequency conversion. The mixer 53 mixes the receiving signal amplified in the amplifying circuit 52 and the high-frequency signal generated in the oscillator 54 to down-convert the receiving signal. The band pass filter 55 which selectively passes only the receiving signal down-converted in the mixer 53 (i.e., the intermediate frequency signal).

The end terminal fixture 16 is formed on a side wall of the support case 12. An arm fixture 18 protrudes obliquely toward a beam emission direction of the feedhorn 10 from the side wall. The arm fixture 18 is for securing the converter 8 to a front end section of the arm 6 drawn from the parabolic reflector 4. The arm fixture 18 is integrally formed of synthetic resin together with the feedhorn 10 and the support case 12. A screw hole for screwing on to the arm 6 is bored in the arm fixture 18.

As noted above, in the converter 8 of the present embodiment, the feedhorn 10 and the support case 12 are integrally formed of synthetic resin. The conductive layer is formed, by metal plating, on the opening end side surface and the inner side surface of the feedhorn 10, and the inner side surface of the support case 12 which surrounds and shields the signal converter 50 of the circuit board 30 together with the shield case 40.

In the feedhorn 10 and the support case 12, a cross-sectional surface of a corner section surrounded by two or more wall surfaces on which the conductive layer is to be formed by metal plating is formed into an arc shape so as not to allow an air space to be formed at the time of plating.

Particularly, a corner section, in which the plating liquid is difficult to flow and in which an air space is easy to be formed, exists on the bottom surface of the groove section 22 between the outer wall of the feedhorn 10 and the wall section 20 around the outer wall of the feedhorn 10 on the opening end side of the feedhorn 10, and on the bottom surface of a concave section 26 (see FIG. 3B) formed inside the support case 12. The cross-sectional surface of the corner section is formed into an arc shape having a radius of 1-1.5 mm so that an air space is not formed in the corner section.

The plating of the feedhorn 10 and the support case 12 with metal is performed according to the following steps. Firstly, a layer of copper is formed on the surface of the feedhorn 10 and the support case 12 by nonelectrolytic plating using copper. Thereafter, a nickel layer or chromium layer is formed on the layer of copper by electrolytic plating.

In the present embodiment, the width (an interval) of the groove section 22 formed between the outer wall of the feedhorn 10 and the wall section 20 around the outer wall of the feedhorn 10 is set to about 3 mm which is necessary for the groove section 22 to be plated. Depending on the conditions at the time of the plating, however, defective plating may result inside the groove section 22. Therefore, some parts of the wall section 20 (four parts, that is, up, down, right and left parts seen from the opening surface side of the feedhorn 10 in the present embodiment) are notched to the bottom surface of the groove section 22 (see notches 24 shown in FIG. 2A). Thereby, the plating liquid reliably enters into the groove section 22 and uniformly plates the interior of the groove section 22. The width of each notch 24 is set to about 5 mm so as not to affect the receiving characteristic of the converter 8.

According to the converter 8 of the present embodiment, it is possible to avoid creating a section unable to be plated due to formation of an air space in the groove section 22 on a periphery of the feedhorn 10 and in the corner section inside the support case 12 at the time of nonelectrolytic plating of the feedhorn 10 and the support case 12. In later electrolytic plating, it is possible to inhibit each section from being unevenly plated. Deterioration can be avoided of the receiving characteristic of the converter 8 due to such defective plating.

One embodiment of the present invention is described in the above. However, the present invention is not limited to the above-described embodiment, but can take various modes within the scope not departing from the gist of the invention.

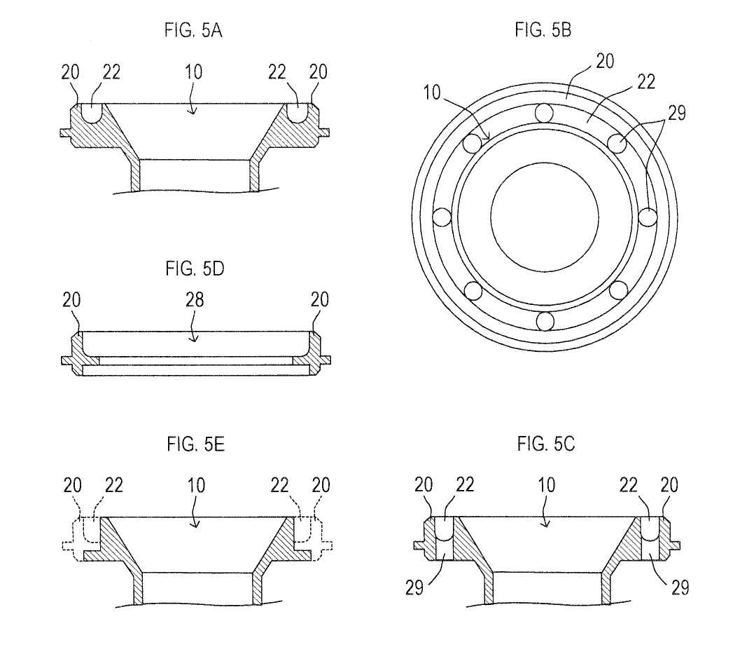

For example, in the above embodiment, the width of the groove section 22 is set to about 3 mm, and the corner section formed in the bottom of the groove section 22 is formed into an arc shape having a radius of 1-1.5 mm. These sizes can be arbitrarily set in consideration of the receiving characteristic and plating performance. For example, as shown in FIG. 5A, the width and the depth of the groove section may be consistent. The cross-sectional surface of the groove section may be formed into a U-shape.

Particularly, for example, in case that the frequency of a received satellite broadcast radio wave is 12 GHz, a length from the opening end section on the feedhorn 10 side to the opening end section on the wall section 20 side of the groove section 22, via the side wall, the bottom surface and the side wall of the groove section 22, requires about 12.5 mm. In this case, the cross-sectional surface of the groove section 22 may be formed into a U-shape so that the width and the depth of the groove section 22 are about 5 mm.

For example, in the above embodiment, the notches 24 are formed in some parts of the wall section 20 so that the plating liquid may be easy to enter the groove section 22. For example, as shown in FIGS. 5B and 5C, a plurality of holes 29 (holes having substantially the same radius with the width of the groove section 22 in the figures) may be bored which penetrate the bottom surface to a back end surface of the groove section 22. In this manner, the plating liquid becomes easy to enter the interior of the groove section 22 through the holes 29 at the time of plating. Defective plating can be inhibited.

FIG. 5B is a front view taken from the opening end side of the feedhorn 10. FIG. 5C is a cross sectional view showing a state of the feedhorn 10 cut through a pair of right and left holes. The holes 29 shown in this figure and the notches shown in FIG. 2A may be respectively formed in one and the same feedhorn 10 only to an extent so as not to affect the receiving characteristic of the converter 8.

In order that the interior of the groove section 22 is reliably plated with metal in forming the corrugated portion 21 on a periphery of the feedhorn 10, the annular member 28 which constitutes a part of the corrugated portion 22 may be constituted separately from the feedhorn 10, as shown in FIG. 5D, and may be fitted and secured to the opening end of the feedhorn 10 using an adhesive or the like, as shown by a dotted line in FIG. 5E. In this manner, the feedhorn 10 may be formed with the corrugated portion 21. In this case, the annular member 28 may be prepared by being formed of synthetic resin, like the feedhorn 10, and plated with metal on its surface.

In the above embodiment, metal plating is applied to the opening end side surface of the feedhorn 10 including the corrugated portion 21 provided with the wall section 20 and the groove section 22, the inner side surface of the feedhorn 10 which serves as a waveguide path, and the inner side surface of the support case 12 from the inner side surface of the feedhorn 10 to the abutment section on which the circuit board 30 abuts. Other sections may be plated with metal, or may remain in synthetic resin without being plated with metal.

In case that the whole periphery of the feedhorn 10 and the support case 12 is plated with metal, it is preferable that at least the arm fixture 18 remains in synthetic resin without being plated with metal. This is because, if the arm fixture 18 remains in synthetic resin having an insulation property, the converter 8 and the parabolic reflector 4 are insulated at the arm fixture 18 when the converter 8 is secured to the arm 6. The converter 8 is kept from being grounded to the earth.

In the above embodiment, the feedhorn 10 and the support case 12 are integrally formed of synthetic resin. These components may be separately formed and brought together with an adhesive or the like having a conductive property.

What is claimed is:

1. A satellite broadcast receiving converter comprising:
a feedhorn to which a satellite broadcast radio wave is input;
a circuit board on which a converting element for receiving and converting the satellite broadcast radio wave to an electric signal is mounted; and
a support case which is provided on a periphery on a back end side of the feedhorn, and which supports and positions the circuit board at a position at which the satellite broadcast radio wave can be received,
the feedhorn and the support case being made of synthetic resin formed by plating a surface of the synthetic resin with metal,
at least an opening surface side surface and an inner side surface which serves as a waveguide path, of the feedhorn being plated with metal,
at least an inner side surface of the support case positioned between an inner wall of the feedhorn and a ground pattern of the circuit board being plated with metal, and
a cross-sectional surface of a corner section surrounded by two or more wall surfaces of metal-plated sections of the feedhorn and the support case is formed into an arc shape so as not to allow an air space to be formed at a time of plating.

2. The satellite broadcast receiving converter according to claim 1 wherein the feedhorn and the support case are integrally formed of synthetic resin.

3. The satellite broadcast receiving converter according to claim 1, wherein a corrugated portion that includes a groove section and a wall section disposed to interpose the groove section is formed on a periphery of an opening end of the feedhorn, and the wall section is partly notched to a bottom surface of the groove section.

4. The satellite broadcast receiving converter according to claim 1, wherein a corrugated portion that includes a groove section and a wall section disposed to interpose the groove section is formed on a periphery of an opening end of the feedhorn, and a hole that penetrates to a back end surface of the groove section is provided in a bottom surface of the groove section.

5. The satellite broadcast receiving converter according to claim 3, wherein a cross-sectional surface of the groove section is formed into a U-shape.

6. The satellite broadcast receiving converter according to claim 1, wherein a corrugated portion is formed on a periphery of an opening end of the feedhorn by fitting a metal-plated annular synthetic resin thereon.

7. The satellite broadcast receiving converter according to claim 1, wherein an arm fixture for fixing the satellite broadcast receiving converter to a front end of an arm drawn from a parabolic reflector to its focal position protrudes from the support case, and the arm fixture is not plated with metal so that the synthetic resin remains exposed.
